(19) United States
(12) Patent Application Publication
(10) Pub. No.: US 2012/0032799 A1
(43) Pub. Date: Feb. 9, 2012

(54) PAINTBALL GUN SYSTEM WITH RATE OF FIRE PAINTBALL MONITORING

(75) Inventors: Christian Williams, Glendale, UT (US); Michael Newman, Smithtown, NY (US); Jukka Fiskari, Helsinki (FI); Sampo Mikkonen, Tervalamp (FI)

(73) Assignee: VIRTUE PAINTBALL, LLC

(21) Appl. No.: 12/850,729

(22) Filed: Aug. 5, 2010

(51) Int. Cl. G05B 23/02; G08B 21/00

(52) U.S. Cl. 340/540; 340/3.1

(57) ABSTRACT

A paintball gun includes a detector that detects the ejection of each paintball and a transmitter that transmits a signal to a remote location indicative of the ejection. The signal is used to determine if the paintball gun is ejecting paintballs at an unacceptable rate and in response, either a warning is generated, or a signal is sent back to inhibit the paintball gun. The signal from the transmitter may include a unique ID for the paintball gun. A command center can receive the signals and generate a statistical record of the operation of each paintball gun in a given playing field.

### RELATED APPLICATION

The subject matter of this application is related to application Ser. No. 11/960,899, filed Dec. 20, 2007 and incorporated herein by reference in its entirety.

### BACKGROUND OF THE INVENTION

1. Field of the Invention

This invention pertains to a paintball gun and aftermarket add-on for a paintball gun that generates signals indicative of an operational characteristic of the gun, such as its rate of fire, and a system, such as the play field in which several participants use these types of guns.

2. Description of the Prior Art

Paintball is an exciting involving players firing paintballs quickly and accurately upon each others using paintball guns which are also known as paintball markers. A typical paintball gun includes a body including a handle with a trigger, a tank holding a compressed gas (typically air or CO₂) and a barrel receiving paintballs from a hopper. Activation of a trigger on the handle causes compressed gas from the tank to propel paintballs through a barrel. Initially, paintball was played with paintball guns that were purely mechanically-operated.

The introduction of electronics into paintball guns has revolutionized the paintball gun and has completely changed the way the game of paintball is played. Electronics have allowed paintball guns to be more than simple mechanical guns. Guns now have electronic circuit boards with computer chips controlling the functions of the gun and providing the paintball player options that were not available with a traditional mechanical gun.

However, it has been suggested that as a result of some of these improvements, the rate of fire of some paintball guns have become so fast that they may provide an unfair advantage to unscrupulous users or may even be dangerous. As a result, there is now a need to monitor some of the operational parameters of paintball guns, such as their rate of fire. Additionally, as the game of paintball has progressed to a sport with complex rules, teams, and competitions, paintball lacks any form of individual or team statistics, which provide legitimacy as a sport and adds value to the overall experience to individual participants.

### SUMMARY OF THE INVENTION

In one embodiment, the present invention pertains to a paintball gun having a body adapted to selectively eject paintballs, a trigger activated by a user, an electronic circuit sensing the activation of the trigger and in response causing the ejection of said paintballs and a transmitter sending signals to a remote location, said being indicative of the ejection of the paintballs for determining a predetermined parameter, such as the rate of fire of paintballs. In one embodiment, the rate of fire is determined within the body and incorporated into the signals. Preferably, the signals further include an ID uniquely identifying the paintball gun.

In another aspect of the invention, a playing field is set up to allow several persons to compete against each other with the paintball guns. A central controller receives the signals from each gun, accumulates the data, and generates information reflecting various parameters of interests, such as the individual rates of fire and other information. This information is then presented in various formats as desired. In one embodiment, a warning is generated if a user causes his gun to fire at a very high rate, and in extreme situations, the command center may send a control command to an individual gun, disabling it temporarily. Additionally, the central controller is able to aggregate signals received from each gun and store it has a unique record for individual players and teams and calculate various statistical metrics, which can be used to benchmark an individual or teams performance. These metrics include average, maximum, and current rate of fire information, player idle time, as well as the amount of time a player spends shooting in a single game or over his lifetime. In one embodiment, additional metrics other t can be recorded into the database such as wins, loses, or other performance metrics and calculated in combination with rate of fire metrics to quantify how many shots per elimination an individual or team fires or how many shots per win or loss or other statistical information.

### BRIEF DESCRIPTION OF THE DRAWINGS

FIGS. 1A and 1B show somewhat diagrammatic side views of an electronic paintball gun constructed in accordance with this invention;

FIG. 2 shows a block diagram of some of the internal components of the paintball gun of FIG. 1;

FIG. 3 shows a playing field with two teams of several players using the guns of FIGS. 1-2;

FIG. 4 shows a block diagram of some of the internal components of an alternate embodiment of the invention;

FIG. 5 shows a block diagram illustrating the operation of a central monitoring/control system on the field of FIG. 4;

### DETAILED DESCRIPTION OF THE INVENTION

Various preferred aspects and embodiments of the present invention will now be described in detail with reference to the accompanying figures. It should be noted, however, that the following description is provided by way of example only and not of limitation, and that many other implementations and embodiments of the present invention will be readily apparent to those skilled in the art based on the disclosure herein. The scope of the invention should therefore not be limited to the particular embodiments described herein.

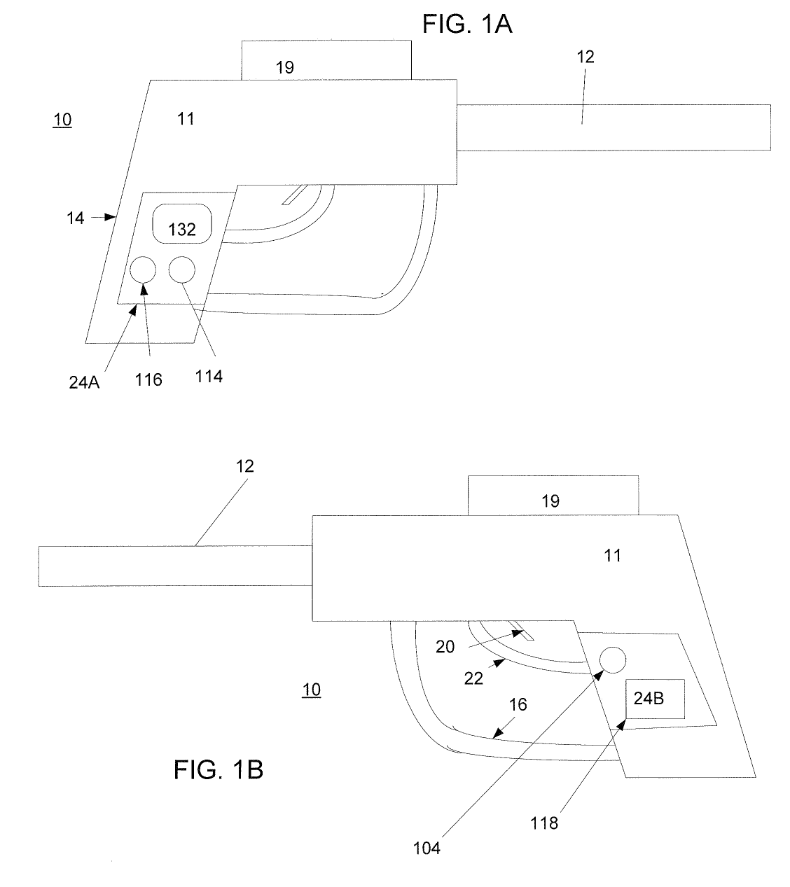

In FIG. 1 a side view of a paintball gun is portrayed somewhat diagrammatically in order to illustrate its operation and the various improvements provided by the present invention. A paintball gun 10 includes a body 11, with a barrel 12 and a handle 14. The body 11 is attached by standard tubes to a source of compressed gas. The source and the tubing have been omitted for the sake of simplicity. Alternatively, the compressed air source may be built into the handle 14 or body 11, and replaced through a small hinged door (not shown) formed therein.

The barrel 12 is selectively connected to the air tank by valves (not shown) and a gas line 16. Attached to the body 11 (or the barrel 12 is a magazine 19 containing paintballs (not shown). Although the magazine 19 is shown mounted right on top of the body 11 for the sake of simplicity, in most paintball gun configurations, the paintballs are fed into the barrel 12 from a closed paintball holder through a hopper (not shown).

The gun 10 is also provided with a trigger 20 protected by a guard 22. In one embodiment, a user aims the gun 10 at a target and pulls the trigger 20. This action causes the valves and other mechanisms within the body 11 to feed a paint ball from the magazine 19 to be loaded and then ejected at a high speed through the barrel 12. The gun 10 can be normally operated in various modes, such as semi-automatic mode, in which a single paintball is ejected each time the trigger 20 is pulled, a burst mode in which a predetermined number of paintballs are being ejected every time the trigger 20 is depressed, an automatic mode in which as long as the trigger 20 is depressed, the paintballs are ejected continuously, or as well as other modes.

The handle 14 is formed with two removable panels 24A, 24B one on each side of the handle. Alternatively, the front portion of the handle is removable and formed of the two panels 24A, 24B connected to form a single U-shaped assembly. The panels 24A, 24B are removable to allow access to the interior of the handle 14. Also provided on the gun are several visual indicators, which may be merely warning lights, such as lights 114, 116, a buzzer or speaker 104, or could be a more complicated display such as an LCD display 132 on which messages could be displayed. The operation of these elements is discussed in more details below.

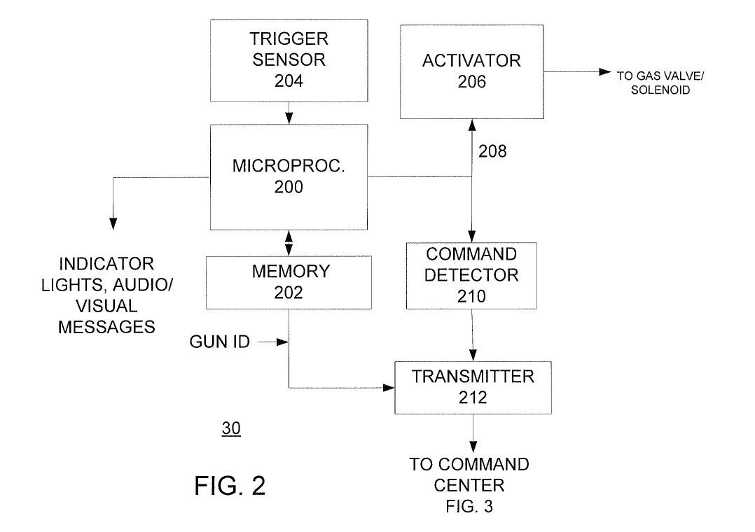

Referring now to FIG. 2, inside the gun, a control circuit 30 including a microprocessor 200 running software programs stored in a memory 202 is provided. A trigger sensor 204 senses when the trigger 20 is activated and sends an appropriate message to the microprocessor 200. The microprocessor 200 then sends a command to an activator 206 on command line 208 requesting that that a paint ball be ejected. The activator 206 then generates an analog or digital activation signal to either a gas valve or a solenoid (depending on the mechanism actually utilized in the respective gun 10) that initiates the process for feeding a paintball into barrel 12 and then ejecting it. One such command is issued for each paint ball. Therefore, if the gun is in semi-automatic mode, a single command is issued. If in a burst or fully automatic mode, the microprocessor 200 issues as many commands as programmed.

The microprocessor 200 may monitor other parameters associated with the operation of the gun 10, such as the number of the total number of balls that have been fired, etc., and activate lights 114, 118, the buzzer/speaker or other indicators in a conventional manner, to provide information to the user, as described in the co-pending application Ser. No. 11/960,899 filed Dec. 20, 2007.

Importantly, according to this invention, the control circuit 30 further includes a ball request detector 210 that detects each time a command has been generated for a ball. In one embodiment, the detector 210 is connected to the command line 208 so that it can intercept each command to the activator 206. Once a command for a paintball has been detected, the detector 210 sends an output signal to an RF transmitter 212. The transmitter 212 receives the output signal from the command detector 210 and an ID code from memory 202 identifying the particular gun. The transmitter then sends the output signal and the gun ID to a master command center. The operation of the command center is described in more detail below.

The embodiment described above is particularly useful when the present invention is provided as an add-on component to an existing gun. In this situation, all the components, except for the command detector 210 and the RF transmitter 212 exist, usually as a single assembly on a common PC board. Typically in such constructions, the microprocessor 202 and activator 206 are interconnected by a plug-type command line 208. The present invention is implemented by providing the command detector 210 and the RF transmitter as a small subassembly, and replacing the plug-in command line 208 with a T-shaped wire harness connecting the microprocessor 200, the activator 206 and the command detector 210 to perform the functions described, with another connector providing the coupling to the memory 202. In an alternate embodiment, the command detector 210 detects the output of the trigger sensor itself rather then waiting for the microprocessor 200.

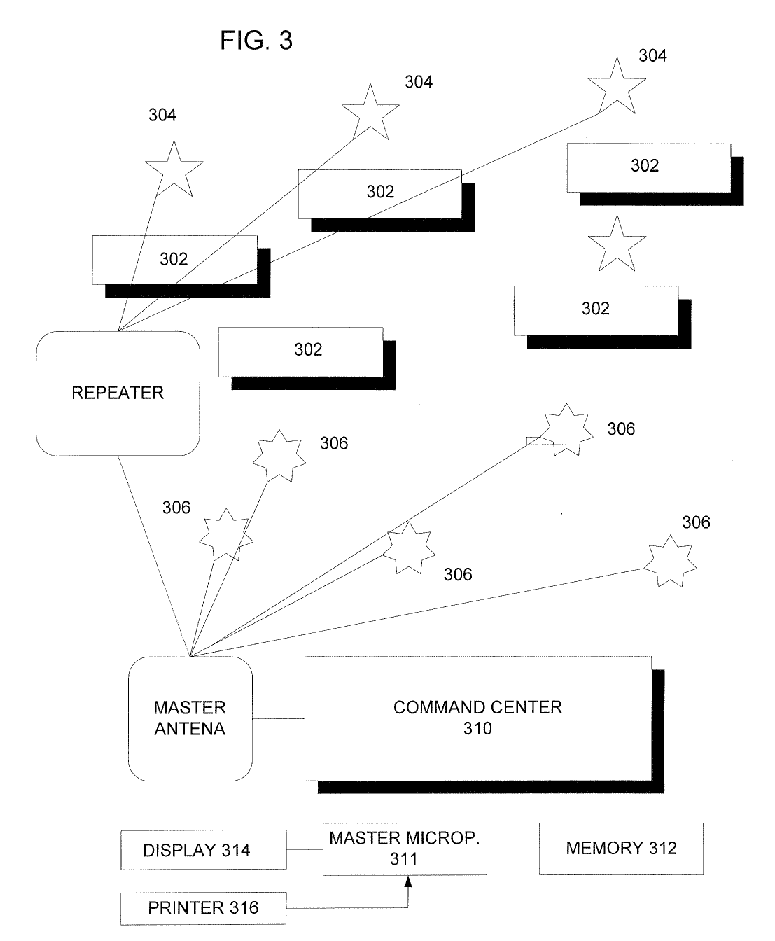

Before explaining the operation of the invention any further, it is helpful to provide a more physical description of the environment in which the paintball gun is used. Referring now to FIG. 3, a field is shown in which the there are provided several obstacles or barriers 302 of various sizes and shapes. The field 300 is used for a competition by two or more teams, in this case a first team with members 304, and a second team with members 306, each of the members 304, 306 having a paintball gun 10.

All activities on the field 300 are monitored by a command center 310. The command center 310 includes a master microprocessor 311 associated with a memory 312, a display 314 and a printer 316. The microprocessor 311 receives signals from the various guns 10 used by the team members through a master antenna 318. In some cases, the field 300 may be very big and/or the RF transmitters 212 may be either too small, or their range/intensity may be limited by various FCC or other regulations, as a result of which their transmissions may not reach master antenna 318. In these cases, one or more repeaters 320 are used, each repeater 320 receiving signals from some of the players 304, 306, and transmitting them to the master antenna 318 and the command center 310.

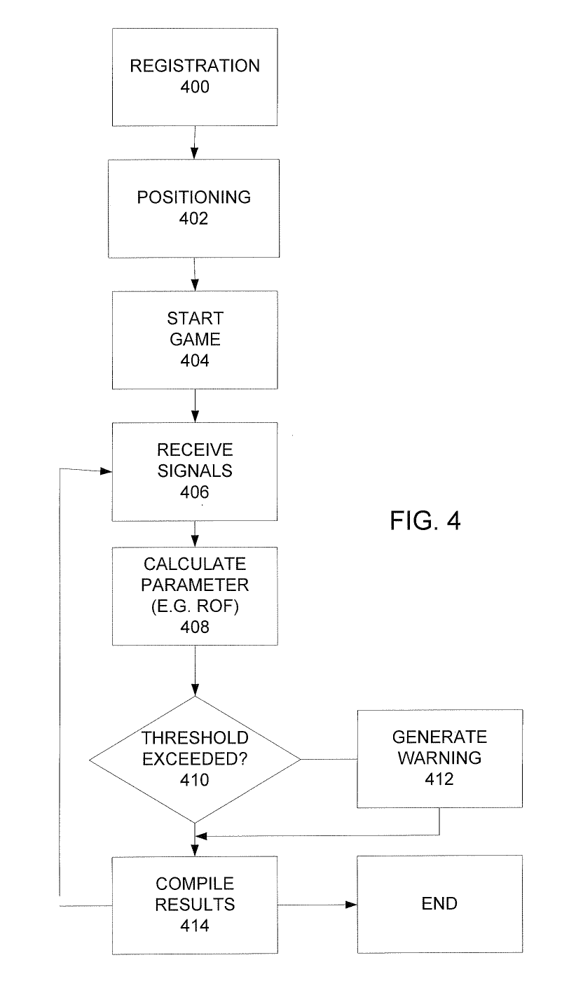

The operation of the system of FIG. 3 as well as the individual guns of FIGS. 1 and 2 shall now be described in conjunction with the flow chart in FIG. 4. At the beginning of each play, each player registers with the command center providing his name and the ID of his gun. In some instances, some, or all the players are issued guns by the command center. In addition, players are provided with protective gear, clothing, and/or ID badges, numbers attached to the clothing, etc.

Next, the players 304, 306 are dispersed on the field 300 accordingly taking up various positions (step 402). The game then starts (step 404) and players start shooting each other or at various targets. Each time, a gun ejects (e.g., fires) a paintball, the master microprocessor 311 receives a signal from the individual transmitters 212 indicating the event. The microprocessor 311 then calculates the number of shots fired by each gun within a specific period of time (e.g., per minute), and, optionally, the total number of shots per gun since the beginning of the play (step 408). In step 410, the rate of fire and/or the total number of shots are compared for each gun to a predetermined threshold 410. This step is desirable, because it is important for various reasons to insure that no gun fires at an excessive rate for the sake of the safety of other players. These parameters may be useful for other purposes as well. If the parameter(s) exceeds a threshold, then in step 412 a warning is generated. The warning may be a flag on the record for the corresponding player. Alternatively, based in individual policies of such facilities, a supervisor may contact the player directly or through a referee on the field and indicate to the player that the mode of operation is unacceptable. If the facility so desires, the player may even be asked to leave the game. This phase is performed for each affected player.

Whether or not one or more players receive warnings or not, the results are compiled and tabulated (step 414) and the process continues by looking for new shots (Step 406) until the game ends. The results are then tabulated for all the players and/or teams, and presented on display 314 or printed on printer 316.

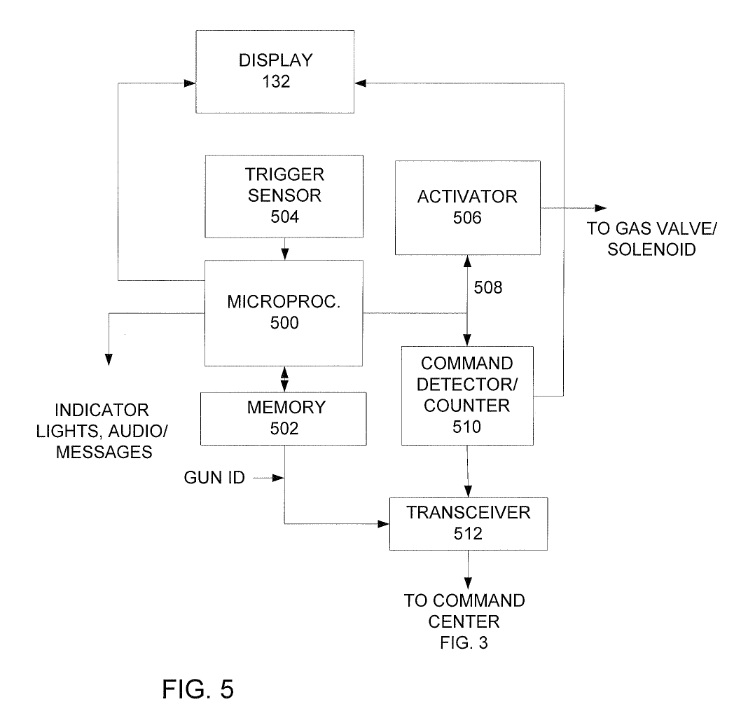

Another embodiment of the invention is shown in FIG. 5. In this figure, a gun 50 has; a microprocessor 500, a memory 502, trigger sensor 504, an activator 506, and command line 508 all of which operate essentially in the same manner as their counterpart in FIG. 3. However, gun 500 further includes two improvements. One is that the command detector 510 is also a counter that counts that the rate of fire (i.e., the number of balls ejected in a preselected period of time, and optionally the total number of balls fired since the beginning of the game. This information is sent to the command center 308 for processing in a manner similar to the previous embodiment. Optionally, this information is also shown on the display 132.

In one embodiment, during or as a game progress, information from each player and/or team is tabulated and presented in terms as a chart, table, etc., listing some or all of the following information:

Name of each player/team

Transmitter ID

Signal strength

First shot taken (time)

Shots fired

Average rate (balls/sec)

Latest rate (balls/sec)

Peak rate (balls/sec)

Shooting time

Shooting %

Idle time

Last Update

Another new feature is that the gun 50 is now in synchronous or asynchronous two-way communication with the command center. That is, at regular intervals, external signals are received from the command center. These external signals are decoded by decoder and are provided to the microprocessor 500 that analyzes and acts upon them. The external signals may include commands, as well as information of general or specific interest. For example, these signals may include information to each player indicating when each play is starting and ending. This information may be in the form of a simple announcement or may be in the form of a countdown indicating how many second or minutes there are before a game begins or ends. In one embodiment, the guns are all disabled when the players enter field 300. The microprocessor 500 is configured to enable the guns so that they can be used to shoot only after the game has commenced. Optionally, at the end of a game, all the guns can be disabled so that they cannot fire anymore.

The command detector/counter is shown in the present application as being part of the embodiment with the transceiver 512 as well. Of course, it could be used as part of the embodiment of FIG. 2 as well. In either case, the count determined by command detector/counter 510 can be transmitted in each embodiment to the command center and/or shown on the local display 132. The embodiment of FIG. 5 can also be implemented with a simple command detector so that the counting function is performed only at the master station.

Importantly, in one embodiment, when a determination is made that a gun is firing at an acceptable rate, and/or has fired too many shots, a signal can be sent either directly from the command detector/counter 510 or the master microprocessor to disable the gun, either for a limited time, or for the duration of the game.

Finally, it should be understood that the various general or specific information can be presented on the display 132 and/or by other visual or audio signals using LEDS 114, 116, speaker/buzzer 104, etc.

Numerous other modifications and variations to the foregoing embodiments are possible and will be apparent to those skilled in the art. For example, ear phones and/or other devices can be connected to the microprocessor not only through an audio connector, but via other connection means as well including, e.g. a USB connector. The appended claims should therefore be interpreted to cover all such modifications and variations.

We claim:

1. A paintball gun comprising:
a body receiving paintballs and selectively ejecting said paintballs;
a trigger operated by a user to cause the ejection of the paintballs;
an electronic circuit disposed in the body, said electronic circuit being configured to control the paintball ejection in response to the trigger activation; and
a transmitter coupled to said electronic circuit and sending signals to a remote system indicative of the ejection of paintballs.

2. The paintball gun of claim 1 wherein said transmitter transmits signals indicative of the ejection of each paintball.

3. The paintball gun of claim 1 wherein electronic circuit includes a command detector detecting commands requesting the ejection of paintballs, and said transmitter is coupled to said detector and is configured to send said signals in the presence of said commands.

4. The paintball gun of claim 3 wherein said electronic circuit prevents the ejection of paintballs if a predetermined signal to it is transmitted.

5. The paintball gun of claim 1 wherein said transmitter is configured to send signals incorporating a unique ID identifying the paintball gun.

6. The paintball gun of claim 1 further comprising a display generating messages for the user and a transceiver receiving signals including said messages.

7. The paintball gun of claim 1 wherein said electronic circuit includes a rate-of-fire detector detecting a rate of fire of said paintballs and said signal is indicative of said rate of fire.

8. A system for conducting paintball games by a plurality of users having paintball guns ejecting paintballs on demand, said system comprising:
a command center receiving signals from said paintball guns indicative of the ejection of balls therefrom, said command center including a processor compiling information from said signals, generating a report listing some of said users and information related to the ejection of balls from the paintball guns of the respective users, and presenting said report.

9. The system of claim 8 wherein said command center includes a printer printing said report.

10. The system of claim 8 wherein said command center further comprises a display displaying said report.

11. The system of claim 9 wherein said processor is adapted to determine information related to the rate of fire from said paintball guns.

12. The system of claim 9 further comprising a repeater receiving signals from some of said paintball guns and transmitting said signals to said processor.

13. The system of claim 9 wherein said processor receives signals indicative of the rate of fire of individual paintball guns.

14. The system of claim 13 wherein said processor is adapted to generate a warning signal when the rate of fire meets a predetermined criteria.

15. The system of claim 13 wherein said processor is adapted to generate a disabling signal to be transmitted to said paintball guns when a predetermined criteria is detected.

16. The system of claim 8 wherein said processor receives signals including information identifying each paintball gun and a parameter associated with said paintball gun.

17. The system of claim 9 wherein said processor receives signals identifying each paintball gun, and including information specific to the operation of said paintball gun, and wherein said processor is configured to store said information and generate corresponding tracking records for each player.

18. The system of claim 17 wherein said players are divided into teams and wherein said processor is further configured to generate reports including information including statistical data associated with each team.

19. The system of claim 9 wherein said processor is further adapted to send external signals dependent on said report, said signals including at least of one email, SMS, live-streaming, web server publishing, and other electronic data communication means.

20. In a paintball gun having a supply of paintballs, a gun body, a gun barrel, a trigger mechanism attached to said gun body and operated by a user, and adapted to cause a paintball from said supply to be loaded into and be ejected from the gun barrel, the improvement comprising:
a detector that detects the activation of said trigger mechanism; and
a transmitter transmitting a signal to a remote location and indicative of said activation.

21. The improvement of claim 20 wherein each signal is indicative of the ejection of a respective paintball.

22. The improvement of claim 20 wherein said transmitter includes into said signal an ID uniquely identifying said paintball gun.

23. The improvement of claim 20 further comprising a receiver receiving incoming signals from a remote location, wherein at least one incoming signal inhibits the paintball gun from ejecting paintballs.

24. The improvement of claim 23 wherein said incoming signal is received when said outgoing signals indicate that the paintballs are ejected at a rate that exceeds a predetermined threshold.
